(19) United States
(12) Patent Application Publication
(10) Pub. No.: US 2003/0074458 A1
(43) Pub. Date: Apr. 17, 2003

(54) Hybrid hardware/software packet filter

(76) Inventor: Maya B. Gokhale, Los Alamos, NM (US)

Correspondence Address: Milton D. Wyrick, Los Alamos National Laboratory, LC/BPL, MS D412, Los Alamos, NM, 87545, US

(21) Appl. No.: 09/954,866

(22) Filed: Sep. 18, 2001

(51) Int. Cl. G06F 15/16

(52) U.S. Cl. 709/230

(57) ABSTRACT

A hybrid software/hardware packet filter in which rule compiling means creates a rule table, assembles packet acceptance rules, and outputs the acceptance rules to a configurable hardware circuit to create hardware circuits representing the acceptance rules and applying the acceptance rules to the packet and outputting a single bit for each rule indicating whether the packet matched the rule. Linking means receives the match bit vector and links each bit in the match bit vector with the corresponding entry in the rule table and directs the packet to a destination determined by the rule table.

The present invention generally relates to packet filters for verifying information transfers between operating systems over computer networks, and, more specifically to packet filters utilizing both hardware and software. This invention was made with Government support under Contract No. W-7405-ENG-36 awarded by the U.S. Department of Energy. The Government has certain rights in the invention.

### BACKGROUND OF THE INVENTION

A packet filter is used to scan certain fields within a packet to determine whether that packet should be accepted or rejected by the operating system. It is common practice to write rules that specify the action to be taken when certain fields in a packet match certain required conditions. For example, the network administrator might want to log all packets coming to the “ftp” port of a certain machine.

Rules describing the pattern to be matched and the subsequent action to be taken on a match often are expressed in a simple control language, a so-called “little language.” In some realizations, a set of rules is compiled to the machine language of a virtual machine that is then emulated by a software program. The packet is analyzed by running the generated program within the emulated virtual machine.

There are many different rule languages currently in existence. These rule languages include the “snort” language and the Network Flight Recorder's “ncode.” The structure of these languages provides for the ability to check incoming packets, route them to appropriate destinations, and perform other operations such as logging the packet or alerting the network administrator.

Although current languages as embodied in software, provide the necessary verification procedures, they are slow and difficult to adapt for particular verification requirements. That is, it requires significant amounts of time to rewrite code and install the new code in order to provide for a new type of verification. This loss of time is often detrimental to operation of a server computer and to the operation of its packet filtering functions.

The present invention presents a hybrid system to accomplish this function. The hybrid system utilizes both software and hardware to provide much more rapid adaptation to changing rule and requirements for acceptance and routing incoming packets. Although the prior art compiles rules to machine code for a virtual processor, the present invention compiles the rules into actual hardware circuits for evaluation of the rules. This hybrid approach provides much more rapid decision, routing, and other actions.

It is therefore an object of the present invention to provide a packet filter that uses a combination of hardware and software to determine the status of incoming packets.

It is another object of the present invention to provide a packet filter that can be easily reconfigured for changing packet-filtering requirements.

It is still another object of the present invention to provide a packet filter that operates much faster than the prior art filters.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

To achieve the foregoing and other objects, and in accordance with the purposes of the present invention, as embodied and broadly described herein, a hybrid hardware/software packet filter comprises rule compiling means for assembling packet acceptance rules and creating a rule table, and outputting the rule table. A configurable hardware circuit receives the rule table and creates hardware circuits representing the rule table for applying the rule table to the packet and outputting a match bit vector indicating whether the packet matched a corresponding entry in the rule table. Linking means receive the match bit vector for linking the match bit vector with the corresponding entry in the rule table for directing the packet to a destination determined by the rule table.

In another aspect of the present invention and in accordance with its principles and purposes hybrid hardware/software method of filtering incoming packets comprises the steps of compiling a rule table to be applied to incoming packets; configuring hardware to create circuits representative of the rule table; comparing the incoming packets with the circuits representative of the rule table; outputting a match bit vector indicative of whether a packet matches a corresponding entry in the rule table; linking the match bit vector with the corresponding entry in the rule table; and directing the incoming packets to destinations determined by the rule table.

### BRIEF DESCRIPTION OF THE DRAWINGS

The accompanying drawings, which are incorporated in and form a part of the specification, illustrate the embodiments of the present invention and, together with the description, serve to explain the principles of the invention. In the drawings:

FIG. 1 is a block diagram of the rule compiler portion of the present invention.

FIG. 2 is a block diagram of the hardware/software packet processing system of the present invention.

### DETAILED DESCRIPTION

The present invention provides a hardware/software packet filter that operates considerably faster than present software filters. The invention can be understood most easily through reference to the drawings.

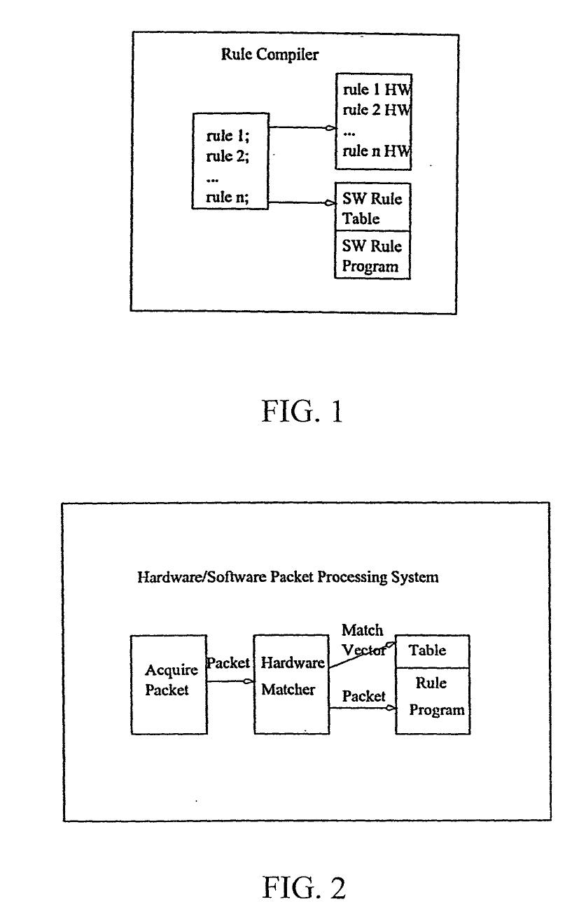

In FIG. 1, the rule compiler 10 portion of the present invention is illustrated in block form. As seen, specified rules 11 are input to configurable hardware circuits 12 and to software rule table 13a in software 13 for processing by software rule program 13b. Rule compiler 10 translates a given textual rule description into some form of machine code. Commonly, this involves encoding the rule description in a software data structure.

Each rule description describes values to match in the fields of interest in the incoming packet. Fields of interest may include, for example, source or destination IP addresses, TCP or UDP port numbers, flags within the header, or content within the packet. Field values may be specific alphanumeric values referred to as “exact match” herein, or may contain wild cards, referred to as “any” herein.

The action to be taken in response to incoming descriptions may be as simple as accepting or rejecting a packet, or may be more complicated, such as logging the packet or generating an alert to a network administrator. The standard semantics for a rule set is that each rule is considered in order until a rule description is matched, and the action associated with that matched rule description is followed.

As shown in FIG. 2, acquired packets 21 are input to hardware matcher 22. Output from hardware matcher 22 consists of match bit vector 22a provided to software rule table 13a, and the packet 22b provided to software rule program 13b. The process of match detection then is to evaluate the data structure of the incoming packet, comparing each field stored in software with the corresponding field in the packet. When a match is identified, the corresponding bit in match bit vector 22a is set. The software rule program then performs the action described in the corresponding software rule table data structure.

In contrast to the prior art practice, the present invention, as illustrated in FIGS. 1 and 2, compiles a portion of each rule directly into hardware circuits 12, and the remainder into software rule table 13a. This practice of employing a combination of hardware and software is in sharp contrast to the purely software approach of filtering intrusion detection programs such as “snort.” As compared to the Berkeley Packet Filter, the present invention generates logic circuits that directly interpret the rule descriptions rather than generate machine code for a virtual machine that is emulated in software.

The generated hardware rule description of the present invention can be loaded onto a Field Programmable Gate Array (FPGA). This arrangement can accelerate packet processing by an order of magnitude over prior art approaches.

The generated hardware of the present invention can be implemented in either of two ways. One way is referred to as the “direct method,” and the other is referred to as the “table-driven method.”

In the direct method, rule compiler 10 (FIG. 1) generates a hardware circuit description in Very High Speed Integrated Circuit Hardware Circuit Description (VHDL), although it could be generated in any appropriate Hardware Description Language (HDL), such as Verilog.

For illustrative purposes only, VHDL is utilized in this description. The output of rule compiler 10 is a VHDL entity definition containing Register-Transfer-Level VHDL. The generated VDHL contains a hardware circuit that realizes the input rule set. The input to this circuit is the set of fields specified in the field definition. Output from this circuit is a single bit indicating either acceptance or rejection.

As an example, the fields consist of:

1. source IP address, a 32 bit number

2. destination IP address, a 32 bit number

3. source port, a 32 bit number

4. destination port, a 32 bit number

5. flag, an 8-bit number.

The rules are as follows:

Rule 1:

dest IP address=any

dest port=any

source IP address=0×80a5cac0

source port=any

action=block

Rule 2:

dest IP address=0×80a5cfbf

dest port=0×19

source IP address=any

source port=any

action=pass

Rule 3:

dest IP address=any

dest port=any

source IP address=any

source port=any

action=block

For the preceding example, with the direct method, the VHDL generated from the above field definitions and rule set follows:

library IEEE;
use IEEE.std_logic_1164.all;
entity G439 is

port

Clk : in std_logic; -- System Clock
Reset : in std_logic; -- System Reset
FLAG: in std_logic_vector(7 downto 0);
DEST_PORT: in std_logic_vector(31 downto 0);
DEST_IP: in std_logic_vector(31 downto 0);
SOURCE_PORT: in std_logic_vector(31 downto
0);
SOURCE_IP: in std_logic_vector(31 downto 0);
result: out std_logic_vector(1 downto 0);

);

end G439;
architecture TL of G439 is
begin

rule_process: process(Clk, Reset)
begin

result <= ‘1’;
if (Reset = ’1’) then result <= ‘1’;
elsif rising_edge(Clk) then

if SOURCE_IP = X80a5cac0 then

result <= ‘1’;
endif;

elsif DEST_IP = X80a5cfbf then

if DEST_PORT = X19 then

result K <=’0’;
endif;

endif;

else result <= ‘1’;

end process;
end RTL;

In pseudo code (see below) used to describe the direct method algorithm, the following applies:

1. for each field definition describing a field f_i create an input port definition p_i

2. create clock and reset input ports

3. create result output port

4. generate boilerplate to initialize result, handle reset, and then

check for rising edge of clock.

5. for each rule j with action action_j,

for each field f_i,

if exact match to a number num_i is specified,

if this is the first exact match

generate “if f_i=num_i then”

else generate “elsif f_i=num_i then”

if action is allow

generate “action_j<=‘0’;”

else generate “action_j<=‘1’;”

for each field f_I

if exact match to a number num_i is specified generate “end if;”

6. generate boilerplate to end the VHDL architecture.

The result match bit vector returned by the hardware is used to index software rule table 13a (FIG. 2). The software portion of the rule corresponding to either the highest priority result or all results may then be evaluated in software 13 (FIG. 1).

In the table-driven method, the present invention configures a Field Programmable Gate Array (FPGA) as a Content Addressable Memory (CAM). The number of CAM slots depends on the type and size of the FPGA and number of unique hardware rule pattern matches desired. FPGAs that can be configured as CAMs include those fabricated by Altera Corporation and Xilinx Corporation. The commercial offerings include “Apex” from Altera Corporation and “Virtex” from Xilinx Corporation.

With the table driven method, rule compiler 10 (FIG. 1) generates a CAM slot entry by concatenating the desired field values. The match vector returned by the CAM is then used exactly as in the direct method described above to trigger evaluation of the software portions of one or more rules.

The above-described table-driven method is more efficient when Boolean components of different rules are disjoint. The previously described direct method can be more efficient when many different rules share common components, as rule compiler 10 can rearrange the control logic to factor out common components and only evaluate each rule once.

It is to be understood that in addition to routing packets to particular destinations, the present invention also can provide intrusion detection. In this case, the packets not only are logged to a destination, but also packets that appear to be suspicious may be directed to a destination where they are logged or an alert of some type could be generated.

Prior art packet filtering methods are not able to keep up with rates above 1 Gb/s. The present invention, using either of the two hardware configurations described, will be one to two orders of magnitude faster.

The foregoing description of the preferred embodiments of the invention has been presented for purposes of illustration and description. It is not intended to be exhaustive or to limit the invention to the precise form disclosed, and obviously many modifications and variations are possible in light of the above teaching. The embodiments were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A hybrid hardware/software packet filter comprising:
rule compiling means for assembling packet acceptance rules and creating a rule table, and outputting said rule table;
a configurable hardware circuit receiving said rule table and creating hardware circuits representing said rule table for applying said rule table to said packet and outputting a match bit vector indicating whether said packet matched a corresponding entry in said rule table;
linking means receiving said match bit vector for linking said match bit vector with said corresponding entry in said rule table and for directing said packet to a destination determined by said rule table.

2. The hybrid software/hardware packet filter as described in claim 1, wherein said configurable hardware circuit is mapped onto a Field Programmable Gate Array.

3. The hybrid software/hardware packet filter as described in claim 1, wherein said rule compiler means also outputs a Hardware Description Language entity definition.

4. The hybrid software/hardware packet filter as described in claim 3, wherein said Hardware Description Language Description entity definition comprises a Very High Speed Integrated Circuit Hardware Description Language Description.

5. The hybrid software/hardware packet filter as described in claim 3, wherein said Hardware Description Language Description entity definition comprises Verilog.

6. The hybrid software/hardware packet filter as described in claim 1, wherein said destination includes logging or an alert being generated in the case of suspicious packets.

7. A method of filtering incoming packets comprising the steps of:
compiling a set of rules to be applied to incoming packets;
configuring hardware to create circuits representative of said set of rules;
comparing said incoming packets with said circuits representative of said set of rules;
outputting a single bit indicative of whether a packet is accepted or rejected;
linking said single bit with a rule table; and
directing said incoming packets to destinations determined by said rule table.

8. The method as described in claim 7, wherein said step of configuring hardware includes a VDHL entity definition.

9. The method as described in claim 7, wherein said directing step includes directing said incoming packets to destinations where suspicious packets are logged.

10. The method as described in claim 7, wherein said directing step includes directing said incoming packets to destinations where suspicious packets cause an alert of some type to be generated.
